(19) United States
(12) Patent Application Publication
(10) Pub. No.: US 2021/0233025 A1
(43) Pub. Date: Jul. 29, 2021

(54) INFORMATION PROCESSING METHOD, INFORMATION PROCESSING APPARATUS AND NON-TRANSITORY STORAGE MEDIUM

(71) Applicant: TOYOTA JIDOSHA KABUSHIKI KAISHA, Toyota-shi (JP)

(72) Inventors: Yoshiyasu TAKEZAWA, Okazaki-shi (JP); Hirotaka TODAKA, Toyota-shi (JP); Takao KIGUCHI, Nagoya-shi (JP); Chieko SAWADA, Nagoya-shi (JP); Yosuke TOKUDA, Toyota-shi (JP); Ayaka KAGAMI, Inazawa-shi (JP); Natsuki SUGIYAMA, Nissin-shi (JP); Takuzo HIRANO, Nagoya-shi (JP); Taichi AMAKASU, Toyota-shi (JP); Seiei HIBINO, Nagakute-shi (JP); Hiroshi KAWAKAMI, Nisshin-shi (JP)

(73) Assignee: TOYOTA JIDOSHA KABUSHIKI KAISHA, Toyota-shi (JP)

(21) Appl. No.: 17/157,250

(22) Filed: Jan. 25, 2021

(30) Foreign Application Priority Data
Jan. 24, 2020 (JP) 2020-010283

(51) Int. Cl. G06Q 10/08

(52) U.S. Cl. CPC G06Q 10/08355; G06Q 10/0833

(57) ABSTRACT

The present disclosure makes it possible to deliver a construction machine through a preferred route. An information processing apparatus identifies, for a construction machine separable into an upper unit and an under unit including a self-propelled mechanism, an upper unit and an under unit to be delivered, based on positions of one or more upper units, positions of one or more under units, a position of a delivery place of the construction machine and a delivery deadline. The information processing apparatus identifies conveying vehicles to be used to convey the upper unit and under unit based on positions of the upper and under units and each position of conveying vehicles. The information processing apparatus calculates movement routes of the conveying vehicles. The information processing apparatus supplies information about the movement routes to terminals placed on the conveying vehicles.

### CROSS REFERENCE TO THE RELATED APPLICATION

This application claims the benefit of Japanese Patent Application No. 2020-010283, filed on Jan. 24, 2020, which is hereby incorporated by reference herein in its entirety.

### BACKGROUND

### Technical Field

The present disclosure relates to an information processing method, an information processing apparatus and a non-transitory storage medium.

### Description of the Related Art

Construction machines (also called heavy machines) include endless-track type work vehicles (tracked vehicles) provided with a metallic crawler such as an excavator, a backhoe and a crane truck. When a tracked vehicle travels on a paved road, the road surface is damaged. Therefore, there is a road surface protection device that can be removably attached to a crawler (see, for example, Patent document 1). There are tracked vehicles including a rubber crawler.

Patent document 1: Japanese Patent Laid-Open No. H08-169371

### SUMMARY

However, a tracked vehicle is not assumed to travel on a public road together with general vehicles and is delivered to a work site using a conveying vehicle such as a truck and a trailer. At this time, a passable road may be limited according to the height and weight of the conveying vehicle loaded with the tracked vehicle. Such a problem is common to cases of delivering a construction machine, including a tracked vehicle, to a work site.

One or more aspects of the present disclosure are directed to provide an information processing method, an information processing apparatus and a non-transitory storage medium making it possible to deliver a construction machine through a favorable route.

One of aspects of the present disclosure may be an information processing method. This information processing method may include: by an information processing apparatus,
identifying, for a construction machine separable into a first portion and a second portion including a self-propelled mechanism, the first portion and the second portion to be delivered to a delivery place of the construction machine, based on information indicating positions of one or more first portions, positions of one or more second portions, a position of the delivery place and information indicating a deadline for delivery to the delivery place;
identifying one or two conveying vehicles to be used to convey the identified first portion and second portion and calculating movement routes for the one or two conveying vehicles to reach the delivery place by the delivery deadline via positions of the identified first portion and second portion, based on the positions of the identified first portion and second portion, positions of one or more conveying vehicles capable of conveying the identified first portion and second portion; and
supplying pieces of information indicating the movement routes to terminals placed on the one or two conveying vehicles.

Aspects of the present disclosure may be an information processing apparatus, a program and a non-transitory storage medium in which the program is recorded. Further, the present disclosure can include disclosure of a terminal that receives information indicating a movement route from the information processing apparatus.

According to the present disclosure, it becomes possible to deliver a construction machine through a preferred route.

### BRIEF DESCRIPTION OF THE DRAWINGS

FIG. 1 is a schematic diagram of an information processing system according to an embodiment;

FIGS. 2A, 2B and 2C are diagrams of a construction machine;

FIG. 3 illustrates a configuration example of a terminal;

FIG. 4 illustrates a configuration example of a server;

FIG. 5 is a flowchart illustrating an example of a process (an information processing method) of the server;

FIG. 6 illustrates an example of a delivery request format;

FIG. 7 is a flowchart illustrating an example of an upper unit and under unit identification process;

FIG. 8 illustrates an example of a data structure of a construction machine database;

FIG. 9 is a flowchart illustrating an example of a conveying vehicle identification process;

FIG. 10 illustrates an example of a data structure of a conveying vehicle DB;

FIG. 11 is a flowchart illustrating an example of a process of deciding the number of conveying vehicles;

FIG. 12 illustrates an example of a delivery instruction format; and

FIG. 13 is a flowchart illustrating an example of a process in the terminal.

### DESCRIPTION OF THE EMBODIMENTS

An information processing method, an information processing apparatus and a non-transitory storage medium according to an embodiment will be described with reference to drawings. A configuration of the embodiment is a mere example, and the present disclosure is not limited to the configuration of the embodiment.

<System Configuration>

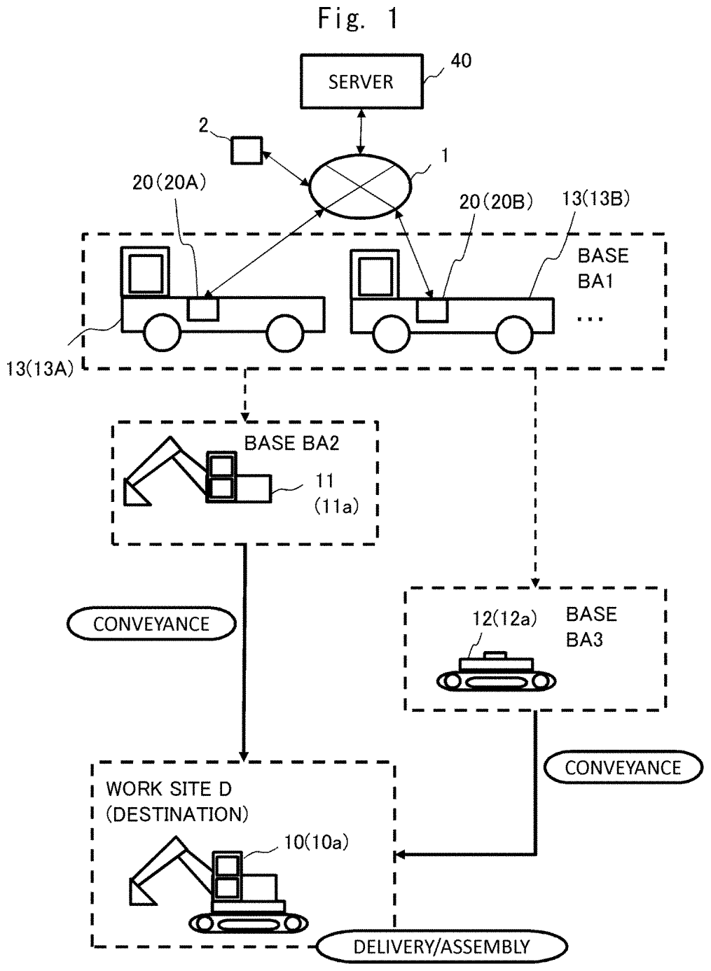

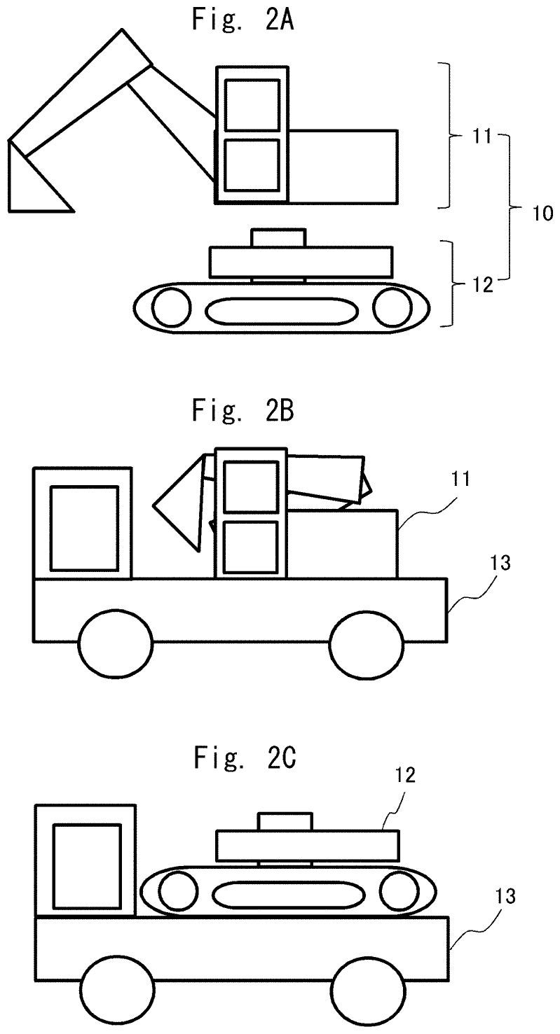

FIG. 1 is a schematic diagram of an information processing system according to the embodiment. FIGS. 2A, 2B and 2C are diagrams of a construction machine. In FIG. 1, the information processing system is a system for delivering a construction machine 10 to lend, to a requested work site. In FIG. 1, the information processing system includes a server 40 connected to a network 1. The server 40 is an example of an “information processing apparatus”. The network 1 is, for example, a public communication network such as the Internet, and a WAN (Wide Area Network) or other communication networks can be adopted. The network 1 may include a cellular network such as LTE (Long Term Evolution) and a wireless network such as a wireless LAN (Local Area Network, including Wi-Fi (registered trademark)).

A terminal 2 and terminals 20 are connected to the network 1. The terminal 2 is a terminal apparatus that transmits information requesting delivery of the construction machine 10. The terminal 2 is a general-purpose or dedicated computer including a communication function, such as a smart device (a smartphone or a tablet terminal) and a laptop computer. The terminal 2 may be a wireless terminal or a fixed terminal. The terminals 20 are placed on conveying vehicles 13 to convey a construction machine.

The construction machine 10 can be separated into an upper unit 11 and an under unit 12 that includes a travel mechanism at the time of being conveyed as illustrated in FIG. 2A and can be assembled (joined) at an appropriate place such as a work site. The upper unit 11 is an example of a “first portion”, and the under unit 12 is an example of a “second portion”.

In the example illustrated in FIGS. 1 and 2, a backhoe (a shovel car) provided with endless tracks, which is an example of a self-propelled mechanism, is illustrated. However, the backhoe is an example, and endless-track type work vehicles other than the backhoe, such as an excavator and a crane truck, are included as the construction machine 10. Further, the construction machine 10 may be other than an endless-track type work vehicle as far as it can be separated into the under unit 12 (the second portion) including a self-propelled mechanism and the upper unit 11 (the first portion). The self-propelled mechanism may be such that enables short-distance movement on a work site and movement on a bad road, like endless tracks, such that uses wheels or such that is self-propelled with a plurality of walking foot. It does not matter whether or not the construction machine 10 can travel alone on a public road. The construction machine 10 may be configured so that, by preparing a plurality of kinds of upper units 11 including different functions, they can be combined with a common under unit 12. It is not necessary to cause the number of under units 12 to correspond to the number of upper units 11. The upper unit 11 and the under unit 12 are not required to be stored at the same place but can be managed at separate places and combined at a work site. A plurality of bases where upper units 11 and under units 12 are placed include business offices, work sites, inspection sites and the like.

The conveying vehicle 13 is a vehicle capable of traveling on a public road, which conveys one of the upper unit 11 and the under unit 12. It is possible to cause the weight and dimensions of a conveyed object to be smaller by conveying the upper unit 11 and the under unit 12 separately than by conveying the upper unit 11 and the under unit 12 in a combined state, and movement route restrictions (such as weight restrictions and height restrictions) are not applied. The conveying vehicle 13 may be adapted so that the weight in a state of being loaded with the upper unit 11 or the under unit 12 does not exceed the weight of the construction machine 10. The conveying vehicle 13 may be a general-purpose vehicle or a dedicated vehicle, including existing vehicles. When a dedicated vehicle is used as the conveying vehicle 13, it is desirable that the conveying vehicle 13 has a configuration of being integrated with the upper unit 11 or the under unit 12 by being joined with the upper unit 11 or the under unit 12 with joining members or fixing members such as bolts and nuts, pins and wires. Further, the conveying vehicle 13 may be such that is driven by a driver or may be such that moves by autonomous driving.

The server 40 accepts a request for delivery of the construction machine 10 to a work site. Information indicating the delivery request is transmitted, for example, from the terminal 2 connected to the network 1. However, a route to acquire the information indicating the delivery request is not limited to the above. The server 40 manages information about positions of a plurality of upper units 11, a plurality of under units 12 and a plurality of conveying vehicles 13. The server 40 performs decision of an upper unit 11 and a under unit 12 to be delivered, decision of a conveying vehicle 13 to be used for conveyance, decision of a movement route of the conveying vehicle 13 and the like according to a request for delivery.

<Terminal Configuration>

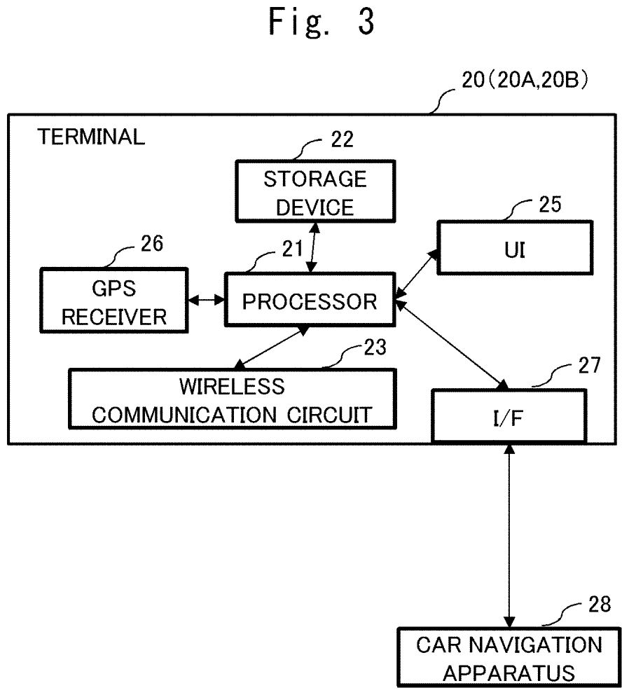

FIG. 3 illustrates a configuration example of a terminal 20 that can be used as each of a terminal 20A and a terminal 20B illustrated in FIG. 1. The terminal 20 may be a terminal apparatus (an onboard terminal) installed in the conveying vehicle 13 or may be a terminal apparatus that is merely placed on the conveying vehicle 13. The terminal 20 may be a smart device such as a laptop personal computer, a smartphone and a tablet terminal. Further, the terminal 20 may be a mobile terminal (a portable communication terminal) such as a personal digital assistant (PDA) and a wearable computer.

The terminal 20 includes a processor 21, a storage device 22, a wireless communication circuit (a communication interface) 23, a user interface (UI) 25 and a GPS (Global Positioning System) receiver 26. The processor 21 may adopt a configuration of being capable of interacting with a car navigation apparatus 28 provided in the conveying vehicle 13.

The storage device 22 includes a main memory and an auxiliary memory. The main memory is used as a program and data storage area, a program development area, a program work area, a communication data buffer area and the like. The main memory is configured by a RAM (Random Access Memory) or a combination of a RAM and a ROM (Read-Only Memory). The auxiliary memory is used as a data and program storage area. As the auxiliary memory, non-volatile storage media such as a hard disk, an SSD, a flash memory and an EEPROM (electrically erasable programmable read-only memory) are included.

The wireless communication circuit 23 is in charge of wireless communication according to a wireless communication method supported by the terminal 20 (LTE, wireless LAN (Wi-Fi (registered trade mark)) or the like). The UI 25 includes, for example, an input device and a display. As the input device, keys, buttons, a pointing device, a touch panel and the like are included, and the input device is used to input information. The display is, for example, a liquid crystal display or the like and displays information and data. The GPS receiver 26 receives a signal from a GPS satellite and calculates a position of the terminal 20. The position of the terminal 20 is used as a position of the conveying vehicle 13 on which the terminal 20 is placed.

The processor 21 is, for example, a CPU (Central Processing Unit) or the like. The processor 21 performs various processes by executing various kinds of programs stored in the storage device 22.

For example, the processor 21 performs transmission/reception of various data and information by communication with the server 40. For example, the terminal 20 can send information indicating the position of the terminal 20 (position information about the conveying vehicle 13) and the like to the server 40. The terminal 20 may adopt a configuration of transmitting conveying vehicle related information, which is information about the conveying vehicle 13, to the server 40. A transmission source of the conveying vehicle related information may be other than the terminal 20. The conveying vehicle related information includes an ID (identifier), information indicating a type, information indicating specifications (length, width, height, weight, maximum load capacity and the like), types of conveyable construction machines 10, information indicating a height, length, width and weight when a construction machine 10 is loaded, and the like of the conveying vehicle 13. The kinds and items of information are mere examples, and it is not essential to be provided with all described above.

As the position information about the conveying vehicle 13, the position information about the terminal 20 may be used as described above, or position information about the GPS receiver fitted to or built in the conveying vehicle 13 may be used. Further, the position information about the conveying vehicle 13 may be such that is acquired by means other than the conveying vehicle 13 and the terminal 20.

The terminal 20 can receive control information about movement of the conveying vehicle 13 (a conveyance instruction) which is transmitted from the server 40. The movement control information includes at least information indicating a destination and a movement route of the conveying vehicle 13 and information indicating a deadline for arrival at the destination (a dead line for delivery). The processor 21 displays an image based on the information indicating the destination and the movement route on a display device included in the UI 25. The processor 21 may determine a movement speed of the terminal 20 (the conveyance vehicle 13) and a scheduled time of arrival at the destination from change in the position of the terminal 20 with elapse of time, and display them on the display. The arrival deadline may be displayed on the display.

An application program for car navigation (a car navigation application) may be installed into the terminal 20, and the movement control information may be set for the car navigation application so that route guidance to the destination and transit points is performed. Further, as illustrated in FIG. 3, the terminal 20 may have an interface circuit 27 connected to the car navigation apparatus 28 mounted on the conveying vehicle 13. Further, the following configuration may be adopted. When the car navigation apparatus 28 is connected, the processor 21 supplies information about the destination and the like to the car navigation apparatus 28. Thereby, the routes to the destination and the transit points, the scheduled arrival time and the like are displayed on the display provided on the car navigation apparatus 28.

<Server Configuration>

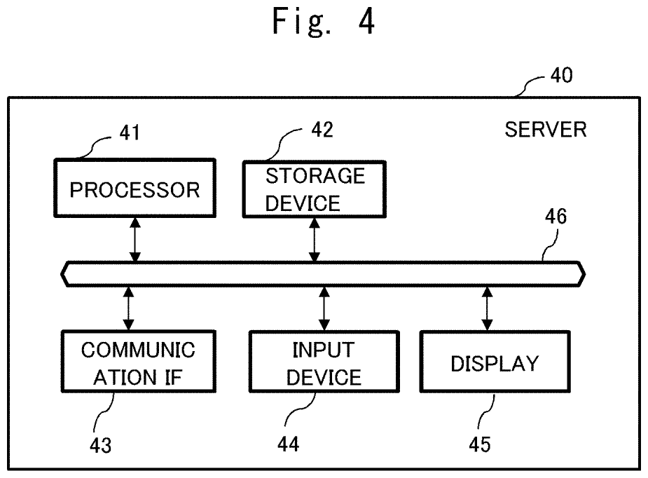

FIG. 4 illustrates a configuration example of the server 40. The server 40 can be configured with a general-purpose information processing apparatus such as a personal computer (PC) and a workstation or a dedicated information processing apparatus such as a server machine. The server 40 includes a processor 41, a storage device 42, a communication interface (a communication IF) 43, an input device 44 and a display 45 that are mutually connected via a bus 46.

As for the processor 41, the storage device 42, the input device 44 and the display 45, those similar to the processor 21, the storage device 22, and the input device and the display described with regard to the UI 25 can be applied. However, those with performances different from performances of those applied to the terminal 20 are applied according to differences in uses and purposes.

The communication IF 43 is in charge of communication processing. As the communication IF 43, for example, a network interface card (NIC) is applicable. The communication IF 43 transmits/receives data and information to/from the terminal 20 and the like via the network 1. By executing various kinds of programs stored in the storage device 42, the processor 41 causes the server 40 to operate as an information processing apparatus that controls movement of the construction machine 10.

Note that, as each of the processor 21 and the processor 41, a plurality of CPUs may be applied, or a multi-core type CPU may be applied. At least a part of processes performed by the CPU may be executed by a processor other than the CPU, such as a DSP (Digital Signal Processor) and a GPU (Graphical Processing Unit), a dedicated or general-purpose integrated circuit such as an ASIC (Application Specific Integrated Circuit) and an FPGA (Field Programmable Gate Array), or a combination of the processor and the integrated circuit. The combination is called, for example, microcontroller (MCU), SoC (System-on-a-chip), system LSI, chip set or the like. A part of processes performed by the processor 41 may be performed by the processor 21.

<Process Examples>

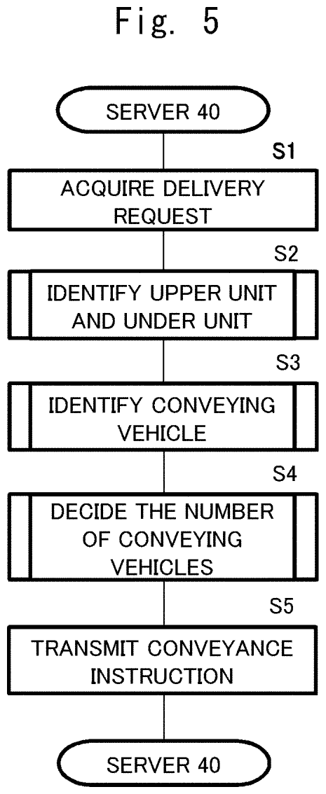

Examples of processes in the server 40 and the terminal 20 will be described below. FIG. 5 is a flowchart illustrating an example of a process (an information processing method) of the server 40. The process in the flowchart is performed by the processor 41 of the server 40.

At step S1, the processor 41 acquires a request for delivery of the construction machine 10. The delivery request may be received from the terminal 2 or a communication terminal other than the terminal 2 via the network 1, or the delivery request inputted to the server 40 via an input device may be accepted. Further, information about the delivery request stored in a storage device connected to the server 40 may be acquired.

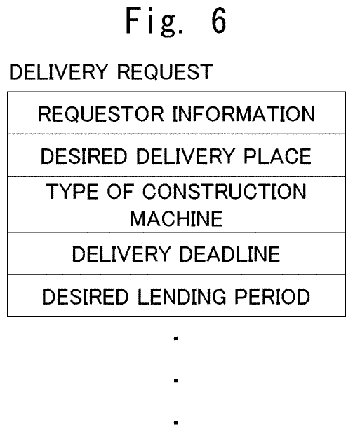

As illustrated in FIG. 6, the delivery request can include requestor information, a desired delivery place, a construction machine type, a delivery deadline, a desired lending period, road restrictions and the like. The requestor information includes information about a requestor's name, a contact address and the like. The desired delivery place indicates a position of a place (a work site, a construction site or the like) to which delivery of the construction machine 10 is desired. The construction machine type is information indicating a type of the construction machine 10. The delivery deadline indicates a deadline for carrying the construction machine 10 into the desired delivery place. The desired lending period indicates a period during which lending of the construction machine 10 is desired. Note that the delivery request may include information indicating weight restrictions and height restrictions (including voluntary restraints) about roads on a work site (such as temporary roads) which the requestor grasps as “road restrictions”. In this case, in search for a route, routes that meet the road restrictions may be excluded from selection targets.

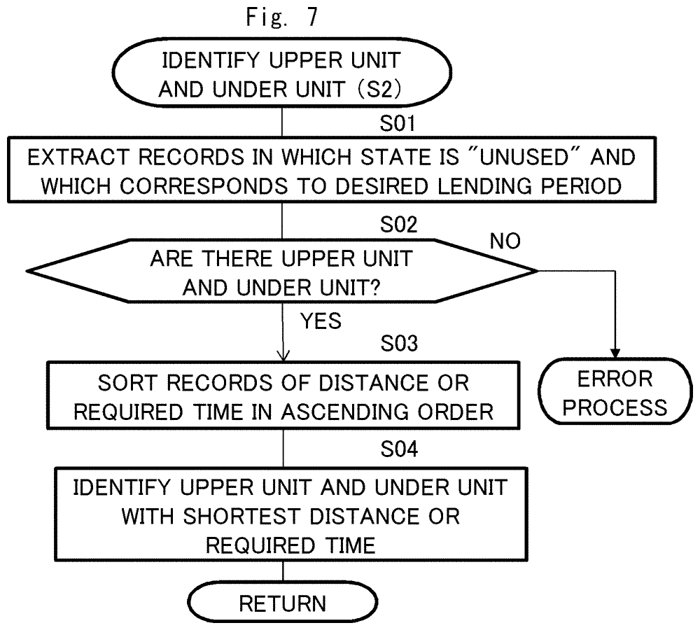

When accepting the delivery request, the processor 41 executes a subroutine for a process of identifying the upper unit 11 and the under unit 12 for the construction machine 10 (step S2). FIG. 7 is a flowchart illustrating an example of the upper unit 11 and under unit 12 identification process.

In the process of step S2, the processor 41 refers to a construction machine DB stored in the storage device 42 to search for upper units 11 and under units 12 for the construction machine 10 that can be lent. Note that the construction machine DB may adopt a configuration of being managed outside the storage device 42 and being accessed by an inquiry of the server 40.

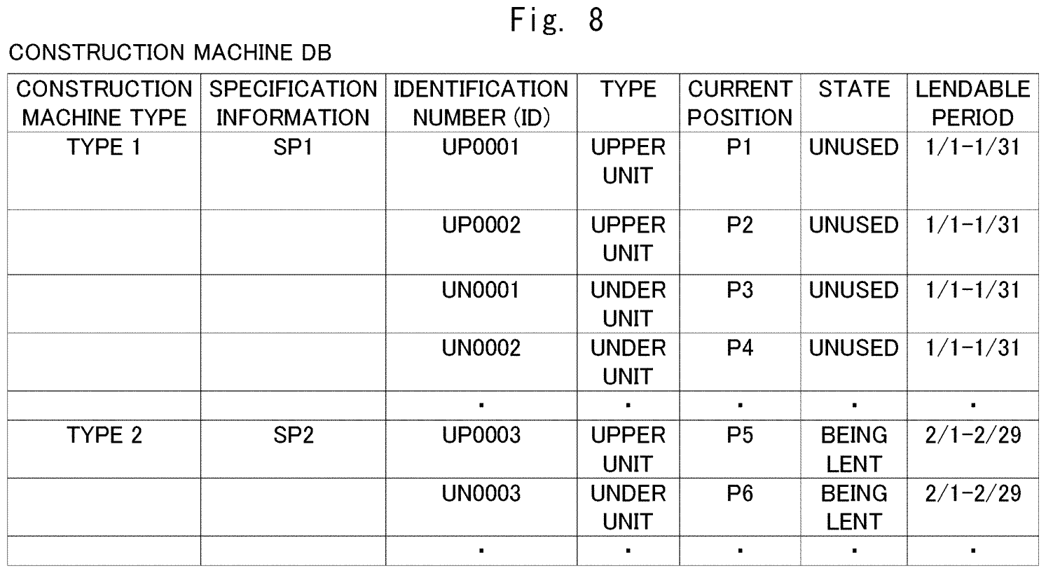

FIG. 8 illustrates an example of a data structure of the construction machine database (the construction machine DB) referred to by the processor 41 in the identification process. The construction machine DB is configured with small tables prepared for construction machine types and pieces of specification information, respectively. Each piece of construction machine specification information includes information indicating a size (a length, a width and a height), a weight, performance, mounted equipment and the like of a construction machine 10. Further, each piece of construction machine specification information includes information indicating a size (a length, a width and a height), a weight and the like of each of upper unit 11 and under unit 12, and compatibility relation between the upper units 11 and the under units 12 (types of under units 12 that can be joined with each upper unit 11 or vice versa). Further, the construction machine specification information includes information indicating suitable types of conveying vehicles 13. Furthermore, for each of the types of the conveying vehicles 13, information indicating a size and a weight of the conveying vehicle 13 in a state in which each upper unit 11 is loaded and a state in which each under unit 12 is loaded.

Each of the small tables of the construction machine DB includes a plurality of records about upper units 11 and under units 12 corresponding to a construction machine type. Each record includes at least an identification number (ID) of an upper unit 11 or an under unit 12, a type (whether upper unit, under unit or conveying vehicle), a current position, a state and a lendable period. As the current position, position information obtained by a GPS receiver attached to the upper unit 11 or the under unit 12 or by another method is recorded. The state indicates one of “unused” and “in use” (including unusable states such as being conveyed, being lent and being inspected)” of the upper unit 11 or the under unit 12. The lendable period indicates a period during which lending is possible in response to a lending request.

At step S01 in FIG. 7, the processor 41 refers to a small table corresponding to the construction machine type included in the delivery request, in the construction machine DB, and extracts records in which the state is “unused”, and the “lendable period” corresponds to the desired lending period of the delivery request.

At step S02, the processor 41 judges whether at least one record of upper unit 11 and one record of under unit 12 are included in the records extracted at step S01. If it is judged that neither a record of upper unit 11 nor a record of under unit 12 is included, a predetermined error process is performed. If it is judged that both records are included, the process proceeds to step S03.

At step S03, the processor 41 calculates a distance between the current position of the upper unit 11 or the under unit 12 included in each of the records and the position of the desired delivery place, or time required for movement between the two, and sorts the records in ascending order of the distance or the required time. To calculate the required time, a case can be assumed where the conveying vehicle 13 travels at a predetermined speed that does not cause a traffic offense.

At step S04, the processor 41 refers to the “type” indicated in the first record among the records rearranged in the ascending order by sorting. If the “type” in this record indicates upper unit 11, the upper unit 11 is identified as a delivery target upper unit 11. The processor 41 searches for records indicating under units 12 that can be joined with the upper unit 11, among the second and subsequent records, and identifies an under unit 12 indicated by a record found first, as a delivery target under unit 12. If the “type” in the first record indicates under unit 12, the processor 41 identifies an upper unit 11 found first from among the second and subsequent records as the delivery target upper unit 11. In this way, the processor 41 identifies an upper unit 11 and an under unit 12 near from the delivery place, an upper unit 11 and an under unit 12, for which a distance or time required to move to the delivery place is the shortest in the present embodiment, as delivery targets. However, the identified upper unit 11 and under unit 12 are not necessary such that the distance or the required time is shortest, but the second or subsequent upper unit 11 and under unit 12 may be identified.

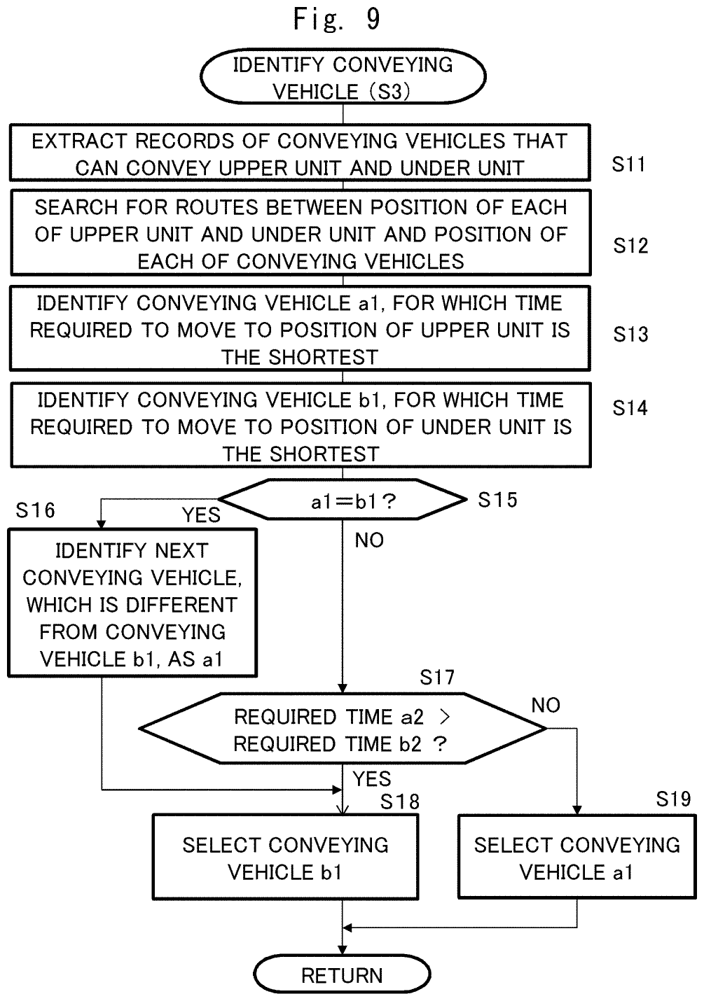

When step S04 ends, the process proceeds to step S3 of a main routine, that is, a conveying vehicle identification process. FIG. 9 is a flowchart illustrating an example of the conveying vehicle identification process. In the process of step S3, the processor 41 searches for a conveying vehicle 13 that can convey the upper unit 11 and the under unit 12, using a conveying vehicle database (a conveying vehicle DB). The conveying vehicle DB may be stored in the storage device 42 or may be managed by a storage device other than the storage device 42. Conveying vehicle related information transmitted from a predetermined transmission source may be registered with the conveying vehicle DB.

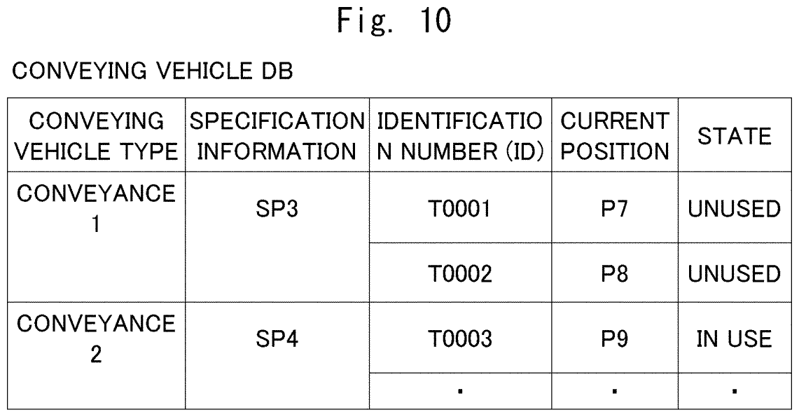

FIG. 10 illustrates an example of a data structure of the conveying vehicle DB. The conveying vehicle DB is configured with small conveying vehicle tables prepared for conveying vehicle type and piece of specification information, respectively. Each piece of conveying vehicle specification information includes information indicating a size (a length, a width and a height), a weight, performance, types of upper units 11 and under units 12 that can be mounted, and the like of a conveying vehicle 13. Each record of each small table of the conveying vehicle DB includes identification numbers (IDs), current positions, states (“unused” or “in use”) and the like of conveying vehicles 13. As the current position of the conveying vehicle 13, position information obtained from the terminal 20 or position information obtained by other method can be used.

At step S11, the processor 41 extracts records of conveying vehicles 13 that can convey the upper unit 11 and the under unit 12 identified by the process of step S2, using the specification information stored in the conveying vehicle DB.

At step S12, the processor 41 searches for routes between the position of each of the upper unit 11 and the under unit 12 and a position of each of the conveying vehicles extracted at step S11, and calculates time required for movement for each of the routes. A movement speed prepared beforehand is used to calculate the required time.

At step S13, the processor 41 identifies a conveying vehicle a1, for which the time required to move to the position of the upper unit 11 is the shortest, among the times required for movement calculated for the routes. At step S14, the processor 41 identifies a conveying vehicle b1, for which the time required to move to the position of the under unit 12 is the shortest, among the times required for movement calculated for the routes. Note that the order of steps S13 and S14 may be in reverse order.

At step S15, the processor 41 judges whether the conveying vehicle a1 and the conveying vehicle b1 are the same conveying vehicle 13 or not. If it is judged that they are the same conveying vehicle 13, the process proceeds to step S16. Otherwise, the process proceeds to step S17.

At step S16, the processor 41 identifies a conveying vehicle next to the conveying vehicle b1, that is, a conveying vehicle 13, for which the time required to move to the position of the upper unit 11 is the second shortest next to the conveying vehicle 13 identified as the conveying vehicle b1, as the conveying vehicle a1. After that, the process proceeds to step S18. In the present embodiment, a configuration is adopted in which, if the nearest conveying vehicle 13 is the same for the upper unit 11 and the under unit 12, the under unit 12 is prioritized. The purpose is to cause the under unit 12 is delivered to a destination earlier than the upper unit 11.

At step S17, lengths of the time a2 required for the conveying vehicle a1 to move to the upper unit 11 and the time b2 required for the conveying vehicle b1 to move to the under unit 12 are compared. At this time, if the required time a2 is longer than the required time b2, the process proceeds to step S18. Otherwise, the process proceeds to step S19.

At step S18, the processor 41 decides that the conveying vehicle b1, for which the time required for movement is short, is to be used for conveyance (selects the conveying vehicle b1 as a conveying vehicle). In comparison, at step S19, the processor 41 decides that the conveying vehicle a1, for which the time required for movement is short, is to be used for conveyance (selects the conveying vehicle a1 as the conveying vehicle).

Thus, the processor 41 identifies a conveying vehicle 13 that is the nearest from the upper unit 11 and the under unit 12 (for which a required time is the shortest) as a conveying vehicle used for delivery. However, the required time does not necessarily have to be the shortest, and there may be a case where the second or subsequent conveying vehicle 13 may be selected due to some situation including the case of step S15. When step S18 or S19 ends, the subroutine at step S3 ends, and the process proceeds to step S4 of the main routine, that is, a process of deciding the number of conveying vehicles.

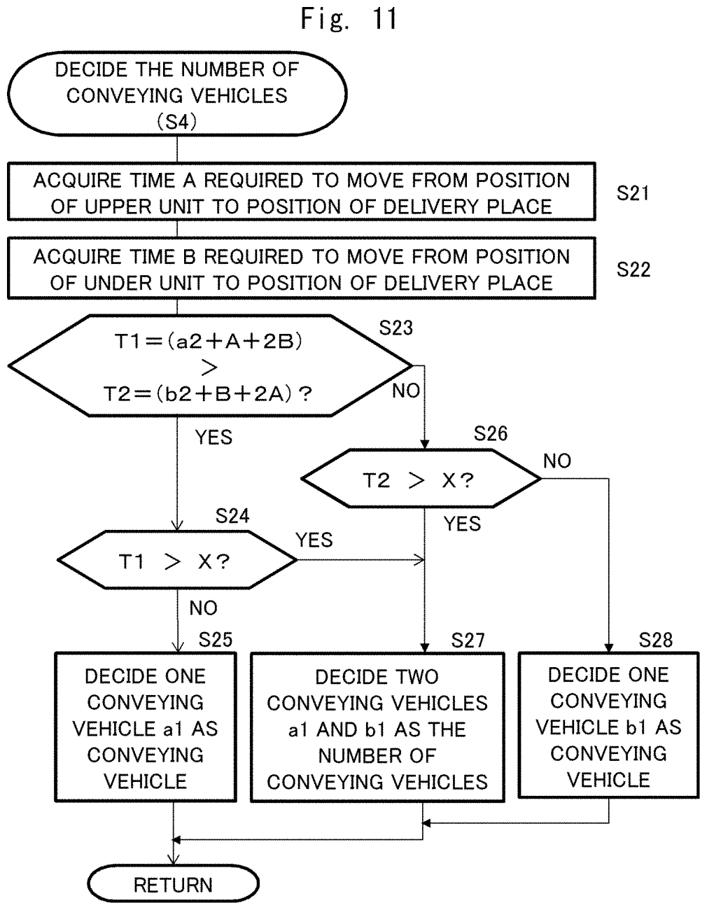

FIG. 11 is a flowchart illustrating an example of the process of deciding the number of conveying vehicles (S4). At step S21, the processor 41 acquires a time A required for a movement route between the position of the upper unit 11 identified at step S2 and the position of the delivery place. Further, at step S22, the processor 41 acquires a time B required for movement for a movement route between the position of the under unit 12 identified at step S2 and the position of the delivery place.

In the present embodiment, the processor 41 performs search of movement routes for determining the times A and B required for movement again, and selects the second or subsequent movement route according to a situation. For example, if the size and weight of the conveying vehicle 13 loaded with the upper unit 11 or the under unit 12 exceed height restrictions and weight restrictions (including voluntary restraints) existing on the shortest movement route, the processor 41 excludes the movement route from targets of calculation of the time A required for movement. Then, the processor 41 decides that the next movement route is to be used for conveyance. It does not matter what route is used to obtain information indicating positions of the height restrictions and the weight restrictions. Note that in a case where it is clear that there are not weight restrictions or height restrictions with regard to routes, and the like, what is calculated in the process of step S03 may be used without performing recalculation. The order of steps S21 and S22 may be in reverse order.

At step S23, the processor 41 calculates the following inequality:

Time T1=(a2+A+2B)>Time T2=(b2+B+2A)

Here, a2 is the time required for the conveying vehicle a1 determined at step S3 to move to the position of the upper unit 11; and 2B is a double value of the time B required for movement. The time T1 is the sum of time for the conveying vehicle a1 to move to the position of the upper unit 11, time to move from the position to the delivery place, and time to go to the position of the under unit 12 from the delivery place and come back from the position of the under unit 12. Here, b2 is the time required for the conveying vehicle b1 determined at step S3 to move to the position of the under unit 12; and 2A is a double value of the time A required for movement. The time T2 is the sum of time for the conveying vehicle b1 to move to the position of the under unit 12, time to move from the position to the delivery place, and time to go to the position of the upper unit 11 from the delivery place and come back from the position of the upper unit 11. If it is judged that the time T1 is longer than the time T2, the process proceeds to step S24. Otherwise, the process proceeds to step S26.

At step S24, the processor 41 judges whether the time T1 is longer than a predetermined time X. When a time length from current time to time specified as the delivery deadline is assumed to be the maximum value, the predetermined time X has a time length obtained by subtracting a predetermined offset time from the maximum value. An appropriate value is set for the offset time. That a positive judgment is made at step S24 means that there is not time enough to deliver the upper unit 11 and the under unit 12 to the delivery place using one conveying vehicle. If it is judged that the time T1 is longer than the predetermined time X, the process proceeds to step S27. Otherwise, the process proceeds to step S25. At step S25, the processor 41 decides one as the number of conveying vehicles 13 used for delivery, the one being the conveying vehicle a1; and ends the process of step S4.

At step S26, the processor 41 judges whether the time T2 is longer than the predetermined time X. That a positive judgment is made at step S26 also means that there is not time enough to deliver the upper unit 11 and the under unit 12 to the delivery place using one conveying vehicle. If it is judged that the time T2 is longer than the predetermined time X, the process proceeds to step S27. Otherwise, the process proceeds to step S28.

At step S27, the processor 41 decides the two conveying vehicles a1 and b1 as conveying vehicles 13 used for delivery, and ends the process of step S4. At step S28, the processor 41 decides the one conveying vehicle b1 as a conveying vehicle 13 used for delivery, and ends the process of step S4.

At step S5 of the main routine, the processor 41 performs a conveyance instruction transmission process. When one conveying vehicle 13 is used, a conveyance instruction is transmitted to a terminal 20 corresponding to the conveying vehicle 13 corresponding to the conveying vehicle a1 or the conveying vehicle b1. Here, “corresponding to” means that the terminal 20 is placed on the conveying vehicle 13 when the upper unit 11 or the under unit 12 is conveyed, and the terminal 20 does not necessarily have to be placed on the conveying vehicle 13 when the conveyance instruction is received. When two conveying vehicles 13 are used, the conveyance instruction is transmitted to two terminals 20 corresponding to the conveying vehicles 13 corresponding to the conveying vehicles a1 and b1, respectively.

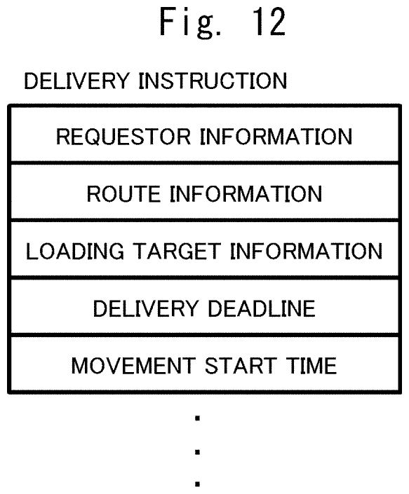

As illustrated in FIG. 12, the conveyance instruction includes pieces of information indicating requestor information, route information, loading target information, a delivery deadline and a movement start deadline, respectively. The route information is information indicating a movement route of the conveying vehicle 13. When delivery is performed by one conveying vehicle 13, information indicating a movement route on which the position of the delivery place is set as a final destination, and each of the position of one of the upper unit 11 and the under unit 12, the position of the delivery place and the position of the other of the upper unit and the under unit is set as a transit point. In comparison, when delivery is performed by two conveying vehicles 13, information indicating a movement route on which the position of the delivery place is set as a final destination, and the position of one of the upper unit and the under unit to be conveyed, as a transit point. A route selection condition (time priority, distance priority or the like) can be included in the route information. In the present embodiment, a condition to select a route with priority on time from among a plurality of route candidates is set. However, the selection condition is not limited to this example.

The loading target information indicates information identifying a loading target upper unit 11 or under unit 12. Further, information about luggage to be loaded with the upper unit 11 or the under unit 12 can be included. The delivery deadline indicates a deadline for arrival at the final destination (delivery place). Further, the delivery deadline may include a deadline for arrival at each transit point.

The movement start deadline indicates a deadline for the conveying vehicle 13 to start movement from the current position, and is decided in consideration of time required for movement of the conveying vehicle 13 on the movement route and a time of stay at each transit point. For example, it is assumed that one conveying vehicle 13 is used for delivery, the delivery dead line is five in the afternoon, and the time required for movement on the route (travel on roads) is three hours. Furthermore, it is assumed that the time of stay at each transit point is one hour (the total time is three hours if there are three transit points of the upper unit position, the delivery place and the under unit position). In this case, time six hours before the delivery deadline is set as the movement start deadline. Note that setting of the movement start deadline may be further performed for each transit point.

An address of each terminal 20 is known to the server 40. The processor 41 generates a message (a packet) including a delivery instruction, and the message is sent out via the communication IF 43 and received by a destination terminal 20 via the network 1.

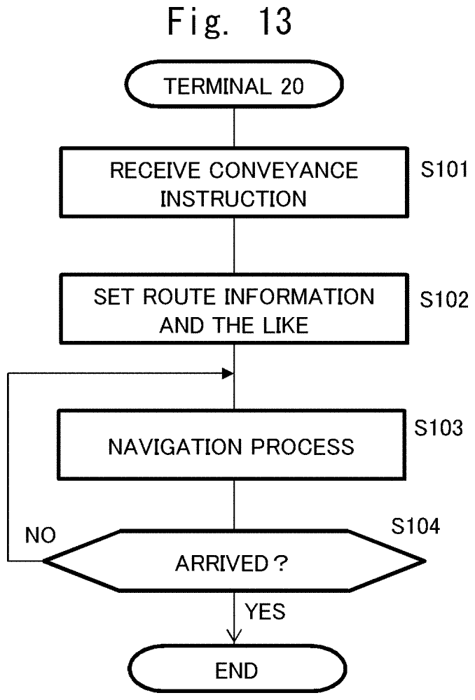

FIG. 13 is a flowchart illustrating an example of a process (an information processing method) in the terminal 20. The processor 21 of the terminal 20 receives the message including the delivery instruction, which is received through the wireless communication circuit 23 (step S101).

At step S102, the processor 21 performs setting of route information and the like. For example, the application program for car navigation (the car navigation application) is installed in the terminal 20, and the processor 21 activates the car navigation application. The processor 21 displays an operation screen of the car navigation application, position information about a destination and transit points included in the delivery instruction and information indicating a route selection condition (time priority), a conveyance deadline and a movement start deadline, on the display included in the UI 25. A driver or the like of the conveying vehicle 13 refers to the information displayed on the display, manually sets the destination and the transit points for the car navigation application, and selects and sets a route with priority on time. The settings may be automatically made.

Or otherwise, the processor 21 may send the position information about the destination and the transit points and the information indicating the route selection condition (time priority) to the car navigation apparatus 28 so that the car navigation apparatus 28 may automatically make settings. Or otherwise, the processor 21 may display the destination and the transit points, and the route selection condition of time priority on the display of the terminal 20, and the driver or the like of the conveying vehicle 13 may manually set a movement route for the car navigation apparatus 28. If the conveying vehicle 13 performs autonomous driving, the route information, the conveyance deadline and the movement start deadline are used as control information for autonomous driving.

At step S103, the processor 21 performs a navigation process with regard to the car navigation application. The processor 21 displays a navigation screen of the car navigation application on the display. On the navigation screen, a current position of the conveying vehicle 13 is displayed on a road map, and scheduled time of arrival at the destination or each transit point, information about travel restrictions based on traffic information received from the network 1 or beacons on roads, and the like are displayed. The deadline for conveyance to the destination (or deadlines for conveyance to the destination and the transit points) may be continuously displayed on the display. Further, when the position of the conveying vehicle 13 does not change (if it can be judged that the conveying vehicle 13 has not started) even if the current time reaches the movement start deadline, the processor 21 may output at least one of a warning beep and an alarm indication to prompt the driver to start. The navigation process is repeatedly performed until it is judged at step S104 that the final destination (the delivery place) is reached. Note that the processes of steps S103 and 104 may be performed as operations of the car navigation apparatus 28.

As an operation example, a situation illustrated in FIG. 1 is assumed. A requestor who desires delivery of the construction machine 10 to a work site D operates the terminal 2 to transmit a delivery request to the server 40 via the network 1.

The server 40 accepts the delivery request and searches for an upper unit 11 and an under unit 12 that meet the delivery request. It is assumed that, as a result of the search, an upper unit 11a located at a base BA2 is selected as an upper unit 11 that is the nearest to the work site D (for which a time required for movement is the shortest), and an under unit 12a located at a base BA3 is selected as the under unit 12 that is nearest to the work site D.

It is assumed that the server 40 selects a conveying vehicle 13A and a conveying vehicle 13B that are located at the base BA1 as conveying vehicles 13 which are the nearest to the positions of the upper unit 11a and the under unit 12a (for which a time required for movement is the shortest) next.

In this case, the server 40 decides the number of conveying vehicles 13 by the process of deciding the number of conveying vehicles 13 (S4). It is assumed that use of the two conveying vehicles 13A and 13B is decided as an example. Then, the server 40 transmits an instruction to convey the upper unit 11a to a terminal 20 (20A) corresponding to the conveying vehicle 13A and transmits an instruction to convey the under unit 12a to a terminal 20 (20B) corresponding to the conveying vehicle 13B.

On the terminal 20A that has received the conveyance instruction, the car navigation application is activated, and route information, conveyance target information, a delivery dead line and a movement start deadline are displayed on the display of the terminal 20A. A driver of the conveying vehicle 13A refers to the information displayed on the display and sets a movement route (with priority on time) that leads to the work site D which is the destination via the base BA2 which is a transit point, for the car navigation application. Then, the driver causes the conveying vehicle 13A to start to the base BA2 by the movement start deadline. When arriving at the base BA2, the driver loads the upper unit 11a onto the conveying vehicle 13A and causes the conveying vehicle 13A to start by the deadline for starting movement to the work site D. In this way, the upper unit 11a is delivered to the work site D by the delivery deadline.

On the terminal 20B that has received the conveyance instruction, the car navigation application is activated, and route information, conveyance target information, the delivery dead line and a movement start deadline are displayed on the display of the terminal 20B, similarly to the terminal 20A. A driver of the conveying vehicle 13B refers to the information displayed on the display, sets a movement route (with priority on time) that leads to the work site D which is the destination via the base BA3, for the car navigation application, and causes the conveying vehicle 13B to start to the base BA3 by the movement start deadline. When arriving at the base BA3, the driver loads the under unit 12a onto the conveying vehicle 13B and causes the conveying vehicle 13B to start by the deadline for starting movement to the work site D. In this way, the under unit 12a is delivered to the work site D by the delivery deadline. At the work site D, work for assembly (combination) of the upper unit 11a and the under unit 12a is performed, and a state in which a construction machine 10 (10a) is delivered is obtained. The construction machine 10a performs desired construction and civil engineering related work while moving itself using the self-propelled mechanism of the under unit 12a.

<Operation and Effects of the Embodiment>

In the present embodiment, the server 40 (the processor 41 as a processing unit thereof) as an information processing apparatus performs the following process, for a construction machine 10 separable into an upper unit 11 as a first portion and an under unit 12 as a second portion including a self-propelled mechanism, by executing a program. In other words, the processor 41 of the server 40 identifies an upper unit 11 and an under unit 12 to be delivered to a delivery place, based on information about positions of one or more upper units 11, positions of one or more under units 12, a position of the delivery place of the construction machine 10 and information indicating a deadline for delivery to the delivery place (step S2).

Based on positions of the identified upper unit 11 and under unit 12 and positions of one or more conveying vehicles 13 that can convey the identified upper unit 11 and under unit 12, the processor 41 identifies one or two conveying vehicles 13 to be used for conveyance of the identified upper unit 11 and under unit 12 (step S3). Further, the processor 41 calculates a movement route for the one or two conveying vehicles 13 to reach the delivery place via the positions of the identified upper unit 11 and under unit 12 by the delivery deadline (step S4). Then, the processor 41 performs a process of supplying (transmitting) a conveyance instruction including information indicating the movement route to terminals 20 placed on the one or two conveying vehicles 13 (step S5). The conveyance instruction is transmitted via the communication IF 43.

According to the present embodiment, the construction machine 10 is separated into the upper unit 11 and the under unit 12, and the upper unit 11 and the under unit 12 are separately delivered to a delivery place (the work site D). Each of the upper unit 11 and the under unit 12 is smaller and lighter than the construction machine 10. Therefore, even for such a road that, in the case of conveying the construction machine 10 (both of the upper unit 11 and the under unit 12), travel on the road has to be avoided due to height restrictions or weight restrictions (including voluntary restraints), it becomes possible to travel on the road because the height and weight is within the range of the restrictions. Therefore, restrictions for a conveyance route are relaxed, and it becomes possible to perform timely delivery in a short required time. Further, by the conveyed object being small-sized and light-weighted, a driving burden on a driver of a conveying vehicle 13 is reduced. Further, at the time of constructing temporary roads on which construction-related vehicles pass, in and around a work site, the weights of the vehicles traveling on the temporary roads can be reduced, and, therefore, temporary road construction costs can be reduced.

In the present embodiment, at the time of identifying an upper unit 11 and an under unit 12 to be delivered to a delivery place, the processor 41 identifies each of an upper unit 11 and an under unit 12, for which a distance or time required for movement from a current position to the delivery place is short (for example, the shortest, but does not necessarily have to be the shortest). By shortening a conveyance distance to reduce energy consumption required for conveyance as described above, costs by conveyance of the construction machine 10 can be decreased.

Further, in the present embodiment, at the time of identifying one or two conveying vehicles 13 used for conveyance of the upper unit 11 and the under unit 12 identified as delivery targets, the processor 41 searches routes between each of positions of the identified upper unit 11 and under unit 12 and positions of a plurality of conveying vehicle candidates registered with the conveying vehicle DB. Further, the processor 41 identifies a conveying vehicle a1, for which a time required to move to the position of the identified upper unit 11 is short, and a conveying vehicle b1, for which a time required to move to the position of the identified under unit 12 is short, from among the plurality of conveying vehicle candidates. The conveying vehicle a1 is an example of a “first conveying vehicle”, and the conveying vehicle b1 is an example of a “second conveying vehicle”. Further, the processor 41 selects the conveying vehicle a1 or the conveying vehicle b1 with a shorter required time (time length), between a time a2 required for the conveying vehicle a1 to move to the position of the identified upper unit 11 and a time b2 required for the conveying vehicle b1 to move to the position of the identified under unit 12, as a conveying vehicle to convey at least one of the identified upper unit 11 and under unit 12. By doing so, it becomes possible to convey the upper unit 11 and the under unit 12 with the nearest conveying vehicles. In other words, conveyance costs can be reduced.

If a certain conveying vehicle among the plurality of conveying vehicle candidates is identified as the conveying vehicle a1 and the conveying vehicle b1, in other words, the same the conveying vehicle 13 is selected as the conveying vehicles a1 and b1, the processor 41 performs the following process. In other words, the processor 41 identifies the certain conveying vehicle as the conveying vehicle b1 (an example of one of the first conveying vehicle and the second conveying vehicle). Further, the processor 41 identifies a conveying vehicle, for which the time required to move to the position of the upper unit 11 (an example of one of the first portion and the second portion) is the second shortest next to the certain conveying vehicle, as the conveying vehicle a1 (an example of the other of the first conveying vehicle and the second conveying vehicle). Thereby, it is possible to select one more conveying vehicle in a case where it is not possible to deliver the upper unit 11 and the under unit 12 by one conveying vehicle. In the present embodiment, the certain conveying vehicle is identified as the conveying vehicle b1. Thereby, it is possible to cause time required to convey the under unit 12 to be shorter than time required to convey the upper unit 11 so that the under unit 12 can arrive at the delivery place first and can be into a state of waiting for being joined with the upper unit 11. As for order of delivery, whichever may be delivered earlier. However, if the under unit 12 is delivered first, the under unit 12 is installed at a scheduled assembly place beforehand to wait for arrival of the upper unit 11, and, thereby, efficient assembly work becomes possible.

Further, in the present embodiment, the processor 41 determines a time T1 (an example of a “first time”) which is the sum of the time a2 required for the conveying vehicle a1 to move to the position of the upper unit 11, a time A required to move from the position of the upper unit 11 to the position of the delivery place and a double value (2B) of a time B required to move from the position of the under unit 12 to the position of the delivery place. Further, the processor 41 determines a time T2 (an example of a “second time”) which is the sum of the time b2 required for the conveying vehicle b1 to move to the position of the under unit 12, the time B required to move from the position of the under unit 12 to the position of the delivery place and a double value (2A) of the time A required to move from the position of the upper unit 11 to the position of the delivery place. Then, the processor 41 compares the time T1 with the time T2, and compares the time T1 or the time T2 with a longer time length with a predetermined time X which is shorter than a time length from current time to time specified by the delivery deadline.

Here, if the time T1 longer than the time T2 is shorter than the predetermined time X, the processor 41 decides to use the conveying vehicle a1 to convey the upper unit 11 and the under unit 12. Otherwise, the processor 41 decides to use the conveying vehicle a1 and the conveying vehicle b1 to convey the upper unit 11 and the under unit 12.

Further, if the time T2 longer than the time T1 is shorter than the predetermined time X, the processor 41 decides to use the conveying vehicle b1 to convey the upper unit 11 and the under unit 12. Otherwise, the processor 41 decides to use the conveying vehicle a1 and the conveying vehicle b1 to convey the upper unit 11 and the under unit 12. In this way, if it is possible to finish delivery of the upper unit 11 and the under unit 12 by the delivery deadline by using one conveying vehicle, use of one conveying vehicle is decided to decrease costs required for delivery. In the case of using two conveying vehicles, it is possible to decrease costs by performing delivery in parallel to finish the delivery in a short time.

In a delivery instruction, the processor 41 supplies information indicating a deadline for starting movement of each of one or two conveying vehicles from a current position, together with information indicating a movement route. Thereby, it is possible to prompt drivers to move timely. Further, information indicating deadlines for starting movement of the one or two conveying vehicles 13 from positions of the upper unit 11 and the under unit 12 is further supplied. Thereby, it is possible to prompt the drivers to start from transit points without delay.

<Others>

The above embodiment is a mere example, and the present disclosure can be appropriately changed and practiced within a range not departing from the spirit of the disclosure.

Further, a process described as being performed by one apparatus may be shared and executed by a plurality of apparatuses. Or alternatively, processes described as being performed by different apparatuses may be executed by one apparatus. In a computer system, by what hardware configuration (server configuration) each function is realized can be flexibly changed.

The present disclosure can be realized by supplying a computer program implemented with the functions described in the above embodiment to a computer, and one or more processors of the computer reading out and executing the program. Such a computer program may be provided to the computer by a non-transitory computer-readable storage medium connectable to a system bus of the computer or may be provided to the computer via a network. As the non-transitory computer-readable storage medium, for example, a disk of an arbitrary type such as a magnetic disk (a floppy (registered trademark) disk, a hard disk drive (HDD) and the like) and an optical disk (a CD-ROM, a DVD disk, a Blu-ray disk and the like), a read-only memory (ROM), a random access memory (RAM), an EPROM, an EEPROM, a magnetic card, a flash memory, an optical card, and a medium of an arbitrary type that is appropriate for storing electronic commands are included.

The components described in the above embodiment can be appropriately combined within a range not departing from the object.

What is claimed is:

1. An information processing method comprising:
identifying, for a construction machine separable into a first portion and a second portion including a self-propelled mechanism, the first portion and the second portion to be delivered to a delivery place of the construction machine, based on information indicating positions of one or more first portions, positions of one or more second portions, a position of the delivery place and information indicating a deadline for delivery to the delivery place;
identifying one or two conveying vehicles to be used to convey the identified first portion and second portion and calculating movement routes for the one or two conveying vehicles to reach the delivery place by the delivery deadline via positions of the identified first portion and second portion, based on the positions of the identified first portion and second portion, positions of one or more conveying vehicles capable of conveying the identified first portion and second portion; and
supplying pieces of information indicating the movement routes to terminals placed on the one or two conveying vehicles.

2. The information processing method according to claim 1, wherein, in the identification of the first and second portions to be delivered to the delivery place, each of a first portion and a second portion, for which a distance or time required to move from a current position to the delivery place is shorter than others, is identified.

3. The information processing method according to claim 1, wherein
in the identification of the one or two conveying vehicles to be used to convey the identified first portion and second portion, routes between each of the positions of the identified first portion and second portion and positions of a plurality of conveying vehicle candidates are searched for;
a first conveying vehicle, for which a time required to move to the position of the identified first portion is shorter than others, and a second conveying vehicle, for which a time required to move to the position of the identified second portion is short, are identified from among the plurality of conveying vehicle candidates; and
the first conveying vehicle or the second conveying vehicle with a shorter required time, between the time required for the first conveying vehicle to move to the position of the identified first portion and the time required for the second conveying vehicle to move to the position of the identified second portion, is selected as a conveying vehicle to convey at least one of the identified first portion and second portion.

4. The information processing method according to claim 3, wherein, if a certain conveying vehicle among the plurality of conveying vehicle candidates is identified as the first conveying vehicle and the second conveying vehicle, the certain conveying vehicle is identified as one of the first conveying vehicle and the second conveying vehicle, and a conveying vehicle, for which a time required to move to one of the positions of the identified first portion and second portion is the second shortest next to the certain conveying vehicle, is identified as the other of the first conveying vehicle and the second conveying vehicle.

5. The information processing method according to claim 4, wherein the certain conveying vehicle is identified as the second conveying vehicle.

6. The information processing method according to claim 4, wherein
a first time that is a sum of the time required for the first conveying vehicle to move to the position of the first portion, the time required for the first conveying vehicle to move from the position of the first portion to the position of the delivery place, and a double value of a time required for the first conveying vehicle to move from the position of the second portion to the position of the delivery place is compared with a second time that is a sum of the time required for the second conveying vehicle to move to the position of the second portion, the time required for the second conveying vehicle to move from the position of the second portion to the position of the delivery place, and a double value of a time required for the second conveying vehicle to move from the position of the first portion to the position of the delivery place;
the first time or the second time, whichever is longer, is compared with a predetermined time shorter than a time length from current time to time specified by the delivery deadline;
it is decided that the first conveying vehicle is used to convey the identified first portion and second portion if the first time longer than the second time is shorter than the predetermined time, and, otherwise, it is decided that the first conveying vehicle and the second conveying vehicle are used to convey the identified first portion and second portion; and
it is decided that the second conveying vehicle is used to convey the identified first portion and second portion if the second time longer than the first time is shorter than the predetermined time, and, otherwise, it is decided that the first conveying vehicle and the second conveying vehicle are used to convey the identified first portion and second portion.

7. The information processing method according to claim 1, wherein pieces of information indicating deadlines for starting movement of the one or two conveying vehicles from current positions are supplied together with the pieces of information indicating the movement routes.

8. The information processing method according to claim 7, wherein pieces of information indicating deadlines for starting movement of the one or two conveying vehicles from the positions of the identified first portion and second portion are further supplied.

9. An information processing apparatus comprising a processor configured to identify, for a construction machine separable into a first portion and a second portion including a self-propelled mechanism, the first portion and the second portion to be delivered to a delivery place of the construction machine, based on information indicating positions of one or more first portions, positions of one or more second portions, a position of the delivery place and information indicating a deadline for delivery to the delivery place; identify one or two conveying vehicles to be used to convey the identified first portion and second portion and calculate movement routes for the one or two conveying vehicles to reach the delivery place by the delivery deadline via positions of the identified first portion and second portion, based on the positions of the identified first portion and second portion, positions of one or more conveying vehicles capable of conveying the identified first portion and second portion; and supply pieces of information indicating the movement routes to terminals placed on the one or two conveying vehicles.

10. The information processing apparatus according to claim 9, wherein, in the identification of the first and second portions to be delivered to the delivery place, the processor identifies each of a first portion and a second portion, for which a distance or time required to move from a current position to the delivery place is shorter than others.

11. The information processing apparatus according to claim 9, wherein
the processor searches for, in the identification of the one or two conveying vehicles to be used to convey the identified first portion and second portion, routes between each of the positions of the identified first portion and second portion and positions of a plurality of conveying vehicle candidates;
the processor identifies a first conveying vehicle, for which a time required to move to the position of the identified first portion is shorter than others, and a second conveying vehicle, for which a time required to move to the position of the identified second portion is short, from among the plurality of conveying vehicle candidates; and
the processor selects the first conveying vehicle or the second conveying vehicle with a shorter required time, between the time required for the first conveying vehicle to move to the position of the identified first portion and the time required for the second conveying vehicle to move to the position of the identified second portion as a conveying vehicle to convey at least one of the identified first portion and second portion.

12. The information processing apparatus according to claim 11, wherein, if a certain conveying vehicle among the plurality of conveying vehicle candidates is identified as the first conveying vehicle and the second conveying vehicle, the processor identifies the certain conveying vehicle as one of the first conveying vehicle and the second conveying vehicle, and identifies a conveying vehicle, for which a time required to move to one of the positions of the identified first portion and second portion is the second shortest next to the certain conveying vehicle, as the other of the first conveying vehicle and the second conveying vehicle.

13. The information processing apparatus according to claim 12, wherein the processor identifies the certain conveying vehicle as the second conveying vehicle.

14. The information processing apparatus according to claim 12, wherein
the processor compares a first time that is a sum of the time required for the first conveying vehicle to move to the position of the first portion, the time required for the first conveying vehicle to move from the position of the first portion to the position of the delivery place, and a double value of a time required for the first conveying vehicle to move from the position of the second portion to the position of the delivery place with a second time that is a sum of the time required for the second conveying vehicle to move to the position of the second portion, the time required for the second conveying vehicle to move from the position of the second portion to the position of the delivery place, and a double value of a time required for the second conveying vehicle to move from the position of the first portion to the position of the delivery place;
the processor compares the first time or the second time, whichever is longer, with a predetermined time shorter than a time length from current time to time specified by the delivery deadline;
the processor decides that the first conveying vehicle is used to convey the identified first portion and second portion if the first time longer than the second time is shorter than the predetermined time, and, otherwise, decides that the first conveying vehicle and the second conveying vehicle are used to convey the identified first portion and second portion; and
the processor decides that the second conveying vehicle is used to convey the identified first portion and second portion if the second time longer than the first time is shorter than the predetermined time, and, otherwise, decides that the first conveying vehicle and the second conveying vehicle are used to convey the identified first portion and second portion.

15. The information processing apparatus according to claim 9, wherein the processor supplies pieces of information indicating deadlines for starting movement of the one or two conveying vehicles from current positions, together with the pieces of information indicating the movement routes.

16. The information processing apparatus according to claim 15, wherein pieces of information indicating deadlines for starting movement of the one or two conveying vehicles from the positions of the identified first portion and second portion are further supplied.

17. A non-transitory storage medium storing a program, the program causing an information processing apparatus to execute a process of:
identifying, for a construction machine separable into a first portion and a second portion including a self-propelled mechanism, the first portion and the second portion to be delivered to a delivery place of the construction machine, based on information indicating positions of one or more first portions, positions of one or more second portions, a position of the delivery place and information indicating a deadline for delivery to the delivery place;
identifying one or two conveying vehicles to be used to convey the identified first portion and second portion and calculating movement routes for the one or two conveying vehicles to reach the delivery place by the delivery deadline via positions of the identified first portion and second portion, based on the positions of the identified first portion and second portion, positions of one or more conveying vehicles capable of conveying the identified first portion and second portion, and
supplying pieces of information indicating the movement routes to terminals placed on the one or two conveying vehicles.

18. The non-transitory storage medium storing the program according to claim 17, the program causing the information processing apparatus to execute a process of identifying, in the identification of the first and second portions to be delivered to the delivery place, each of a first portion and a second portion, for which a distance or time required to move from a current position to the delivery place is shorter than others.

19. The non-transitory storage medium storing the program according to claim 17, the program causing the information processing apparatus to execute a process of:
searching for, in the identification of the one or two conveying vehicles to be used to convey the identified first portion and second portion, routes between each of the positions of the identified first portion and second portion and positions of a plurality of conveying vehicle candidates;
identifying a first conveying vehicle, for which a time required to move to the position of the identified first portion is shorter than others, and a second conveying vehicle, for which a time required to move to the position of the identified second portion is short, from among the plurality of conveying vehicle candidates; and
selecting the first conveying vehicle or the second conveying vehicle with a shorter required time, between the time required for the first conveying vehicle to move to the position of the identified first portion and the time required for the second conveying vehicle to move to the position of the identified second portion as a conveying vehicle to convey at least one of the identified first portion and second portion.

20. The non-transitory storage medium storing the program according to claim 19, the program causing the information processing apparatus to execute a process of, if a certain conveying vehicle among the plurality of conveying vehicle candidates is identified as the first conveying vehicle and the second conveying vehicle, identifying the certain conveying vehicle as one of the first conveying vehicle and the second conveying vehicle, and identifying a conveying vehicle, for which a time required to move to one of the positions of the identified first portion and second portion is the second shortest next to the certain conveying vehicle, as the other of the first conveying vehicle and the second conveying vehicle.
